(19) United States
(12) Patent Application Publication
(10) Pub. No.: US 2007/0121870 A1
(43) Pub. Date: May 31, 2007

(54) Subscription service integration application program interface and schema

(75) Inventors: Jeffrey A. Herold, Bothell, WA (US); Minghui Gao, Redmond, WA (US); Curt Andrew Steeb, Redmond, WA (US); James S. Duffus, Seattle, WA (US); Munisamy Prabu, Issaquah, WA (US); Zeyong Xu, Issaquah, WA (US); Martin H. Hall, Sammamish, WA (US); Muhsin Demirbag, Seattle, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 11/367,608

(22) Filed: Mar. 3, 2006

Related U.S. Application Data
(60) Provisional application No. 60/733,226, filed on Nov. 3, 2005.

(51) Int. Cl. H04M 3/42

(52) U.S. Cl. 379/201.05

(57) ABSTRACT

An application program interface (API) for sending and receiving batches of requests and responses has a batch request call for exchanging one or more request items between a provider system and a subscription system and a batch response call for exchanging corresponding responses between the provider system and the subscription system. Requests are grouped according to an extensible markup language schema and responses are grouped according to another extensible markup language schema.

### CROSS-REFERENCE TO RELATED APPLICATIONS

This patent claims priority from U.S. Provisional Application Ser. No. 60/733,226 which was filed on Nov. 3, 2005 and is expressly incorporated by reference herein.

### BACKGROUND

A subscription services management system enables and manages subscriptions between a provider system and a client. For example, in a subscription for a device, such as a personal computer or software object, a subscription system works with an enforcement module on the subscription device to enforce the policies of a subscription, configure the subscription device, customize the subscription device, provide support and the like.

The provider system communicates with the client regarding the subscription account and includes a separate billing system. For example, the provider system receives and monitors payment for the subscription, receives customer support requests from the client, process changes in the account and the like. Each of these require the provider system to communicate with the subscription system, and the provider system takes appropriate action based on the response provided by the subscription system. However, at any one time there may be hundreds or thousands of clients making requests to enable or renew subscriptions, request support, modify the subscription, etc., thereby resulting in thousands or tens of thousands of requests from the provider system to the subscription system. Each of these requests may differ in context, resulting in complex or numerous application program interfaces (APIs). The integration between the provider system and the subscription system has been hampered by the quantity and differences in the requests, in addition to the amount of network traffic caused by the number of requests.

### SUMMARY

The network interface API between the subscription system and the provider system, along with the batch request and batch response schemas, provides a simplified interface that permits requests to be transmitted and handled asynchronously. Provider systems and subscriptions systems within a subscription network are more fully integrated. Broadly, there are a class of calls for exchanging a group of requests and for exchanging a group of responses. The requests are grouped according to a first extensible markup language schema and the responses are grouped according to a second extensible markup language schema. The use of these calls and schemas is expected to increase the integration between the provider system and the subscription system, while reducing network traffic.

### BRIEF DESCRIPTION OF THE DRAWINGS

FIG. 1 is a simplified and representative block diagram of a computer network;

FIG. 2 is a block diagram of a computer that may be connected to the network of FIG. 1;

FIG. 3 is a representative block diagram of a subscription network;

FIG. 4 is a representative block diagram of a provider system and a subscription system;

FIG. 5 is a representative function diagram of the interaction between the provider system and the subscription system of FIG. 4; and

FIG. 6 is a flowchart representative of a routine for receiving and handling batch requests from the provider system and providing batch responses to the provider system.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed-herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

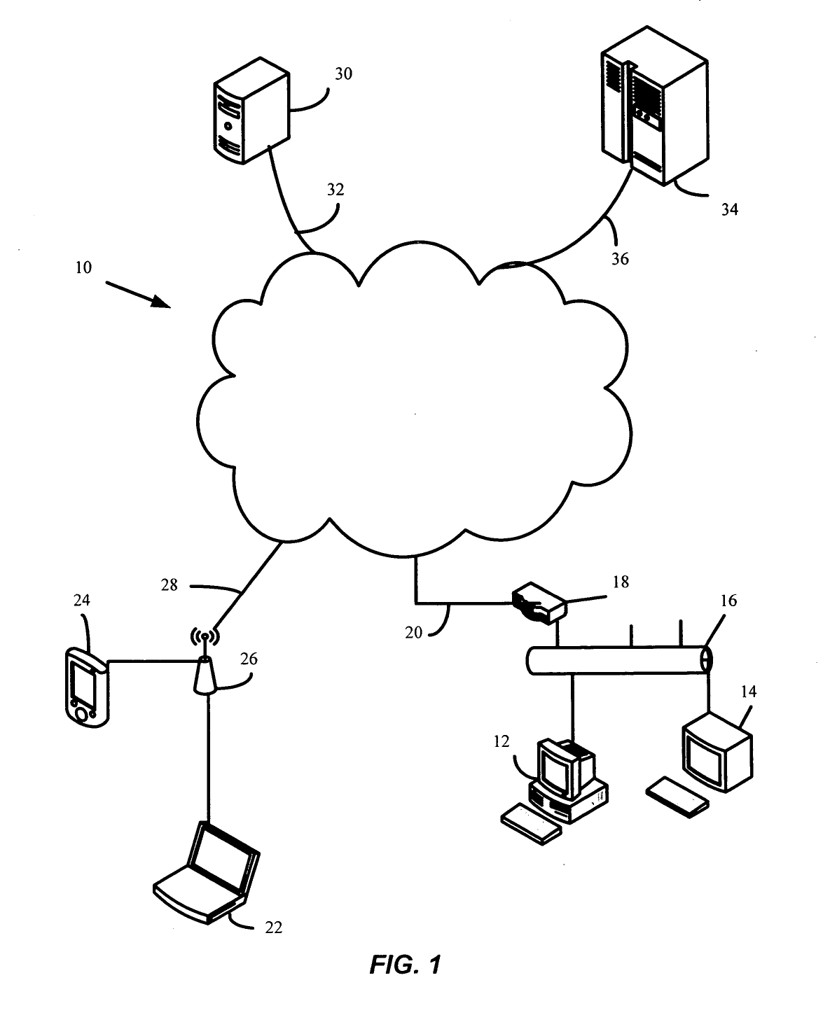

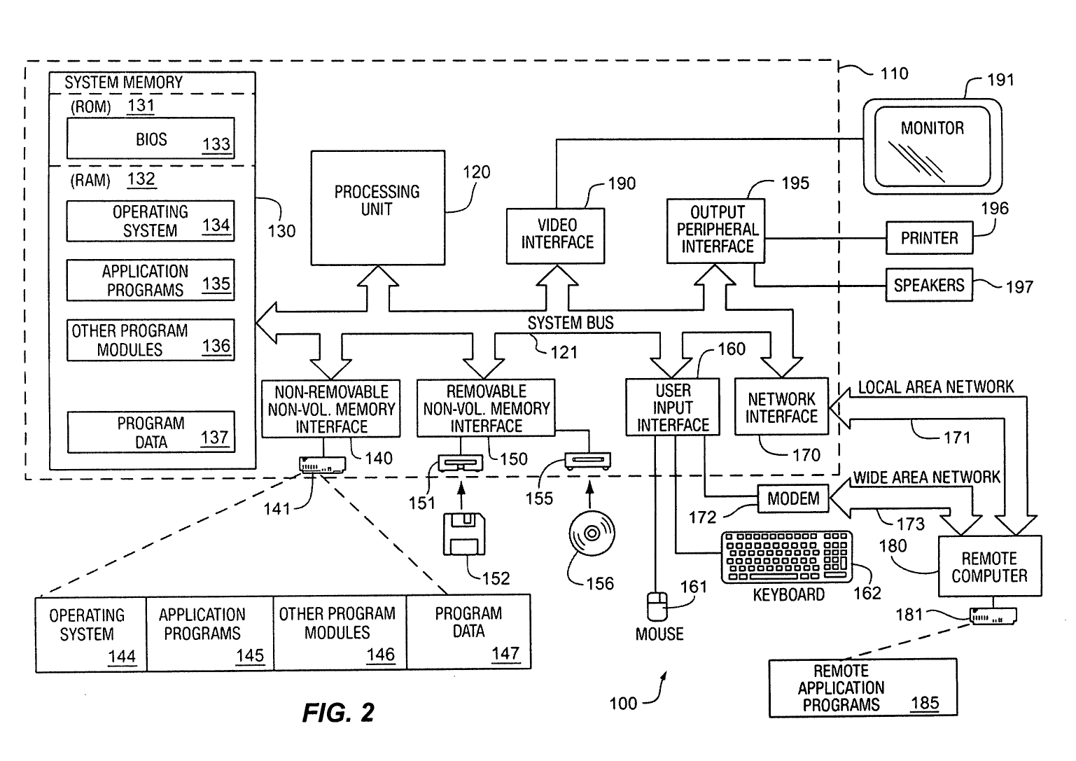

FIGS. 1 and 2 provide a structural basis for the network and computational platforms related to the instant disclosure.

FIG. 1 illustrates a network 10. The network 10 may be the Internet, a virtual private network (VPN), or any other network that allows one or more computers, communication devices, databases, etc., to be communicatively connected to each other. The network 10 may be connected to a personal computer 12, and a computer terminal 14 via an Ethernet 16 and a router 18, and a landline 20. The Ethernet 16 may be a subnet of a larger Internet Protocol network. Other networked resources, such as projectors or printers (not depicted), may also be supported via the Ethernet 16 or another data network. On the other hand, the network 10 may be wirelessly connected to a laptop computer 22 and a personal data assistant 24 via a wireless communication station 26 and a wireless link 28. Similarly, a server 30 may be connected to the network 10 using a communication link 32 and a mainframe 34 may be connected to the network 10 using another communication link 36. The network 10 may be useful for supporting peer-to-peer network traffic.

FIG. 2 illustrates a computing device in the form of a computer 110. Components of the computer 110 may include, but are not limited to a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 2 illustrates operating system 134, application programs 135, other program modules 136, and program data 137.

The computer 110 may also include other removable/non-removable, volatile/nonvolatile computer storage media. By way of example only, FIG. 2 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 2, provide storage of computer readable instructions, data structures, program modules and other data for the computer 110. In FIG. 2, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and cursor control device 161, commonly referred to as a mouse, trackball or touch pad. A camera 163, such as web camera (webcam), may capture and input pictures of an environment associated with the computer 110, such as providing pictures of users. The webcam 163 may capture pictures on demand, for example, when instructed by a user, or may take pictures periodically under the control of the computer 110. Other input devices (not shown) may include a microphone, joystick, game pad, satellite dish, scanner, or the like. These and other input devices are often connected to the processing unit 120 through an input interface 160 that is coupled to the system bus, but may be connected by other interface and bus structures, such as a parallel port, game port or a universal serial bus (USB). A monitor 191 or other type of display device is also connected to the system bus 121 via an interface, such as a graphics controller 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 2. The logical connections depicted in FIG. 2 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the input interface 160, or other appropriate mechanism. In a networked environment, program modules depicted relative to the computer 110, or portions thereof, may be stored in the remote memory storage device. By way of example, and not limitation, FIG. 2 illustrates remote application programs 185 as residing on memory device 181.

The communications connections 170 172 allow the device to communicate with other devices. The communications connections 170 172 are an example of communication media. The communication media typically embodies computer readable instructions, data structures, program modules or other data in a modulated data signal such as a carrier wave or other transport mechanism and includes any information delivery media. A “modulated data signal” may be a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Computer readable media may include both storage media and communication media.

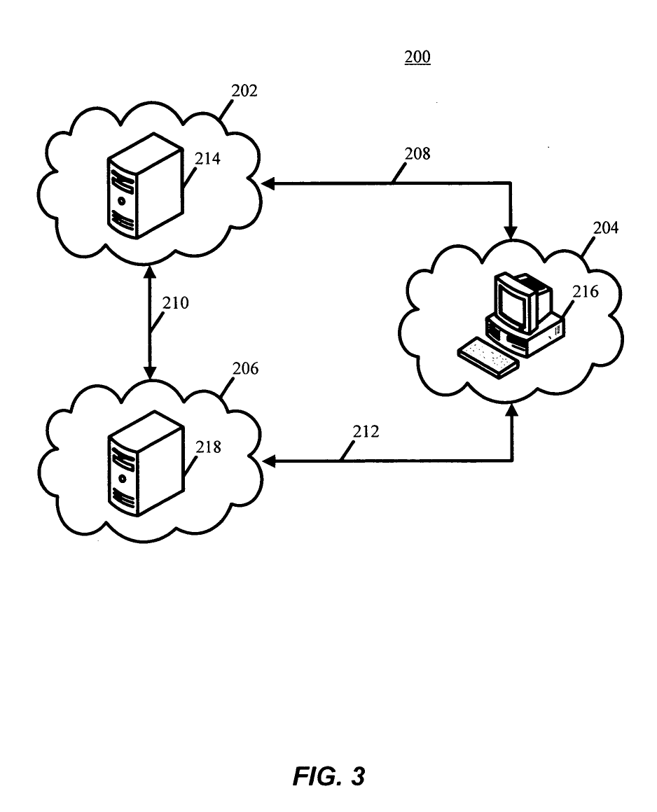

FIG. 3 depicts an exemplary subscription network, that may be similar to or coupled to the network 10 of FIG. 1. A subscription network 200 may include individual systems 202, 204, 206 coupled by networks 208, 210, 212. The networks 208, 210, 212 may be wired or wireless and may support Internet protocol version 6 (IPv6) and secured communications protocol, such as secured sockets layer (SSL). In one example, the Internet is utilized as the networks 208, 210, 212. In an example where systems 202 and 206 are provided on different networks interconnected through the Internet, web services with extensible markup language messaging, such as XML messaging, may be utilized. System 202 is a subscription service management system (SSMS) that includes a subscription server 214. System 204 is a client system that includes a subscription device 216, including, but not limited to a personal computer, a telephone, a personal digital assistant, a set top box, a television, an entertainment system, and the like. In one example, the subscription device 216 may be a personal computing device used to execute a subscription software routine, including, but not limited to, an operating system, an application, and the like. System 206 is a provider system that includes a provider server 218. Although the subscription system 202 is shown to include one subscription server 214, it should be understood that different numbers of servers may be utilized. Likewise, the client system 204 and provider system 206 may include different numbers of subscription devices and servers, respectively. It should also be understood that multiple systems may be provided, including tens or hundreds of provider systems, and hundreds or thousands of client systems. Generally, a particular provider system 206 will communicate with only one subscription system 202.

Generally, the subscription system 202 is a device-centric system that enables and manages subscriptions between the provider system 206 and subscription devices 216 of the client system 204. For example, the subscription system 202 may enable and manage a subscription for a personal computer used by the client. The subscription system 204 handles subscription business logic to enable the client system 204 to subscribe to the service, renew subscriptions, cancel subscriptions, manage the subscription device 216, configure the subscription device 216, limit client access to the subscription device 216, etc. The subscription system 202 may also provide support and diagnostics to the subscription device 216. Further, the subscription system 202 handles requests from the provider system 206 regarding the subscription, including requests for enforcement of the subscription terms, requests to register the subscription device, requests to enable/disable a subscription for the subscription device, requests to configure the subscription device, etc.

The client system 204 includes an enforcement module that allows the subscription system 202 to enforce the terms of the subscription policy, thereby allowing the subscription system to enable, disable or limit a client's access to the subscription device 216. The client system 204 communicates with the subscription system 202 to verify that the subscription account is in good standing from the subscription system 202. The client system 204 further communicates with the provider system 206 regarding the subscription account, billing issues, payments, customer support requests, request changes to the subscription, etc.

The provider system 206 is an account-centric system that manages the billing and accounting for the subscriptions. The provider system 206 communicates with the client system 204 regarding payments, billing issues, responses to customer service requests, etc. The provider system 206 further communicates with the subscription system 202 to request management of the subscription, including the requests for enforcement, the register requests, the requests to enable/disable a subscription for the subscription device, the configuration requests, etc. In many cases, the request items generated by the provider system 206 are prompted based on communications, or lack thereof, with the client system 204, including, but not limited to, delayed payment, lack of payment, support requests, new subscriptions, renewed subscriptions, etc. For each request item, the subscription system 202 generates a response item as a result of the request and provides the response to the provider system 206.

Using the above systems 202, 204, 206, the system 200 enables a client to engage in a subscription account with the provider to use a subscription device. The client provides payment to the provider for the subscription, and uses the subscription device over the course of the subscription according to the terms of the subscription. Based on the client's account with the provider, the provider may initiate a request item for execution by the subscription service management system. In turn, the subscription service management system handles the request items to manage the subscription on behalf of the provider. For example, when the provider wishes to register, re-register or de-register a subscription device, the provider may use the RegisterDeviceRequest described further below. Similarly, when the provider wishes to begin or end a subscription, the provider may use the SubscribeDeviceRequest described further below. When enforcement of the subscription policy is desired, the provider may use the EnforcementLevelType request. The ConfigureDeviceRequest may be used to request configuration of the subscription device, whereas the ConfigureDefaultRequest may be used to configure the default setting for handling subscription devices. The PerpetuateDeviceRequest may be used to perpetuate the subscription of the subscription device, thereby allowing the client to use the subscription device without a subscription. CreateSubscriptionPacketRequest may be used to create a one time subscription packet with a specified end date.

Each request item generated by the provider may be grouped with other request items into a batch request according to a particular schema. The provider system 206 uses an extensible markup language, such as, for example, XML, to enable the communication of the batch request to the subscription system 202. For example, a subscription system schema, such as the BatchRequest call discussed further below, defines how the provider system 206 should create and send the batch request to the subscription system 202. Each request item generated by the provider system 206 is contained in a batch request to provide simplicity to the interface with the subscription system and to define the message context. Because each batch request may contain multiple request items, the request items are organized according to priority. For example, a RegisterDeviceRequest to register a new subscription device 216 should be handled before a SubscribeDeviceRequest to initiate a subscription for the same subscription device 216 because a subscription cannot be initiated before the subscription device 216 is registered. Accordingly, a RegisterDeviceRequest may be listed before the SubscribeDeviceRequest for the subscription device 216 thereby providing handling priority to the RegisterDeviceRequest. In one example, all request items for a subscription device 216 are listed together and organized according to a logical order for handling. In another example, all request items of a particular type for all subscription devices may be organized according to a logical order for handling (e.g., all RegisterDeviceRequest items are listed before all SubscribeDeviceRequest items).

In response to a request item, the subscription service management system handles each request item and generates a corresponding result. For example, in response to the RegisterDeviceRequest, the subscription system 202 registers, re-registers or de-registers the subscription device 216. In response to the SubscribeDeviceRequest, the subscription system 202 periodically generates a subscription packet for the client system 204 detailing the start and/or end of the subscription. In response to the EnforcementLevelType, the subscription service 202 establishes an enforcement level that the enforcement module of the subscription device 216 uses to enforce the subscription policy. In response to the ConfigureDeviceRequest, the subscription system 202 configures the subscription device 216. In response to the ConfigureDefaultRequest, the subscription system 202 configures the subscription device 216 to default settings. In response to the PerpetuateDeviceRequest, the subscription system 202 generates a perpetual provisioning packet for the client system 204 which causes the subscription device 216 to become a perpetual device. In response to the CreateSubscriptionPacketRequest, the subscription system 202 creates a one-time subscription packet for the client system 204 which causes the subscription device 216 to enter a one-time subscription.

For each request item from the batch request, the subscription system 202 generates a response for the provider. The responses are grouped into a batch response according to a particular schema. As with the provider system 206, the subscription system 202 uses an extensible markup language schema, such as XML, to enable communication of the batch response to the provider system 206. For example, a provider batch reply schema, such as the BatchResponse call discussed further below, defines how the partner should establish its batch reply system and receive the batch response from the subscription service. Generally, the subscription system 202 defines the schemas for both the batch request and the batch response. The interface between the subscription system 202 and the provider system 206 is thus provided as a simple interface design thereby avoiding multiple implementations for accomplishing the same task and simplifying the requester (provider system 206) and the handler (subscription system 202).

Generally speaking, XML enables virtually any type of data or information (including transactional data) to be wrapped or encapsulated with a schema that defines and provides structure (i.e., format) to the information or data. XML is a self-describing language in which the various elements of any given schema describe the encapsulated or wrapped data. XML developed from the same standard that resulted in the development of the now familiar hypertext markup language (HTML), which has become a standard means of conveying graphic display information via the Internet. Although XML encapsulated or wrapped data may be easily transmitted via the Internet, as can HTML formatted data, XML is fundamentally different from HTML because XML provides definition and structure to transmitted data (as opposed to merely formatting the display of transmitted data, which is the case with HTML).

The application program interface (API), schemas and communication techniques described herein enable request and response information, such as the batch request and the batch response, to be exchanged between the subscriber system 202 and the provider system 206. In particular, the API, schemas and techniques described herein group requests and responses into batches such as, for example, the batch request and batch response, using an XML schema that can be easily conveyed between the subscription system 202 and the provider system 206, regardless of whether the communications use the Internet, a LAN or any other communication media and technology. In this manner, the provider system 206 may be more fully integrated with the subscription system 202, and, in particular, the billing functions of the provider system 206 may be more fully integrated with the subscription functions of the subscription system 202.

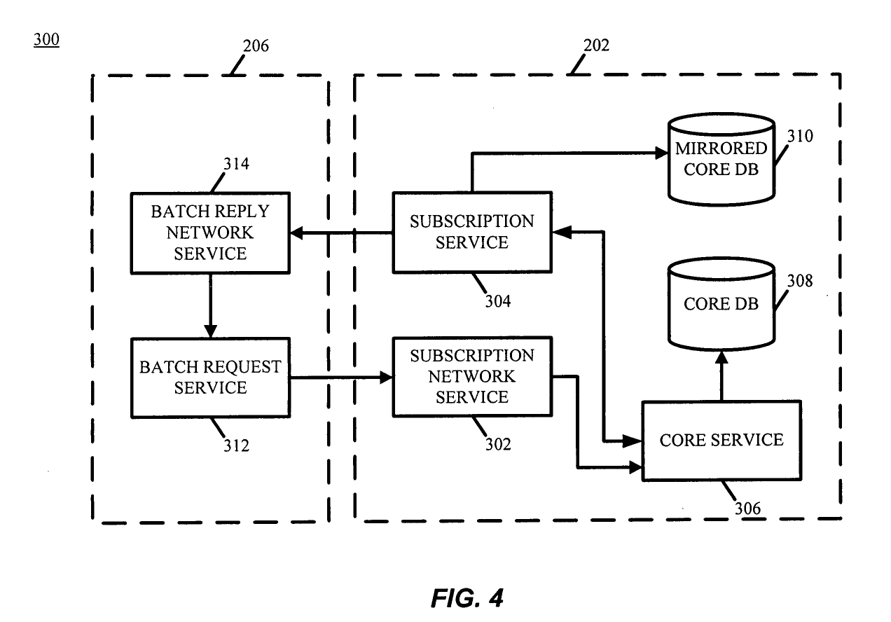

FIG. 4 represents a more detailed block diagram 300 of the subscription system 202 and the provider system 206. Referring to FIG. 4, the subscription system 202 includes a subscription network service 302, a subscription service 304, a core service 306, a core database 308 and a mirrored core database 310. The subscription network service 302 provides an entry point for all requests from the provider system 206. In particular, the subscription network service 302 is a web service that provides a unified web interface and implements the subscription system schema to define the communication interface between the subscription system 202 and the provider system 206. The subscription network service 302 is coupled to the core service 306, and communicates with the core service 306 via a message queue of the core service 306. The core service 306 handles all request items from the provider system 206 via the subscription network service 302, and handles the results. The core database 308 stores the handled request items. The subscription service 304 receives the handling results from the core service 306, validates the results, creates a batch response object which is supplied to the provider batch reply schema. The subscription service 304 also calls back the provider system 206 with the batch response. The subscription service 304 further includes a scheduler to generate packets for the subscription device 216.

The provider system 206 includes a batch request service 312 and a batch reply network service 314. The batch request service 312 initiates request items and sends the batch request to the subscription network service 302. The batch request service 312 conforms to the subscription system schema implemented by the subscription network service 302. Thus, the batch request service 312 includes a network service, such as a web service, according to the subscription system schema. The batch reply service 314 is the callback interface provided by the provider system 206 to receive the batch response provided by the subscription service 304. Similar to the batch request service 312, the batch reply network service 314 conforms to the provided batch reply schema dictated by the subscription service 304. Accordingly, the batch reply network service 31 includes a network service, such as a web service, defined according to the provider batch reply schema. The request channel and the response channel between the subscription system 204 and the provider system 206 are point-to-point.

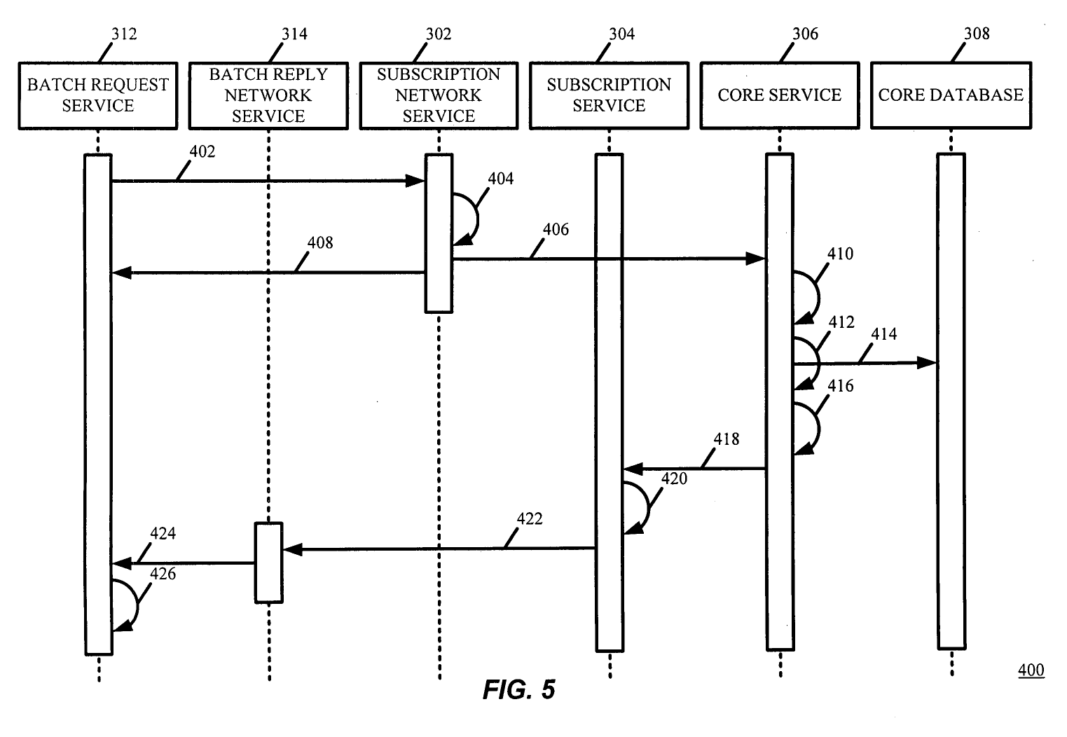

FIG. 5 is a functional diagram 400 indicating the interaction between the subscription system 202 and the provider system 206. Although FIG. 5 shows the interaction for a single batch request and a corresponding batch response, it should be understood that the interaction between the subscription system 202 and the provider system 206 is asynchronous such that additional batch requests may be sent from the provider system 206 before subscription system 202 has finished handling the previous batch request.

Referring to FIG. 5, the provider batch request service sends 402 a batch request to the subscription network service 302. As mentioned above, the batch request is created and sent according to the subscription network service schema. The batch request includes at least one request item and may be limited to a predetermined number of request items (e.g., 10,000 request items per batch request). The request items are organized according to handling priority. The batch request further includes a batch identification to identify the batch request, a provider identification to identify the provider system 206 and input parameters detailing the number of request items.

The subscription network service 302 receives the batch request and validates 404 the batch request according to the batch identification, the provider identification and the input parameters. If validated, the subscription network service 302 generates a message for the core service 306 for handling the request items and sends 406 the message to the message queue of the core service 306. The subscription network service 302 further acknowledges 408 receipt of the batch request, or provides notice to the provider system 206 that the batch request is invalid if any part of the validation fails.

The core service 306 attends to the message according to the order of the message in the queue. The core service 306 creates 410 the request items by breaking out the request items from the batch request. The core service 306 may then handle 412 each request item within the batch and updates 414 the core database as appropriate. Handling results are generated 416 for each request item according to an internal schema. Examples of handling results may include acknowledgements, error messages, warnings, etc. The handling results are sent 418 to the subscription service 304.

The subscription service 304 validates 420 the results to determine if the number of results correspond with the number of request items, validate the batch identification and validate the provider identification. Although the subscription service 304 does not necessarily know the substance of the individual request items, and thus does not validate the substance of the results, the subscription service 304 may validate the syntax of the results (e.g., validate that each result contains information). Accordingly, one batch response maps to exactly one batch request. Once validated, the subscription service 304 generates the batch response and sends 422 the batch response to the batch reply network service 314 according to the batch reply network schema. If the results are not validated, the subscription service 304 may generate an error message. The results are organized in the batch response according to the organization of the corresponding request items.

The batch reply network service 314 receives the batch response and forwards 424 the batch response to the batch request service 312. The batch request service 312 then handles 426 the batch response.

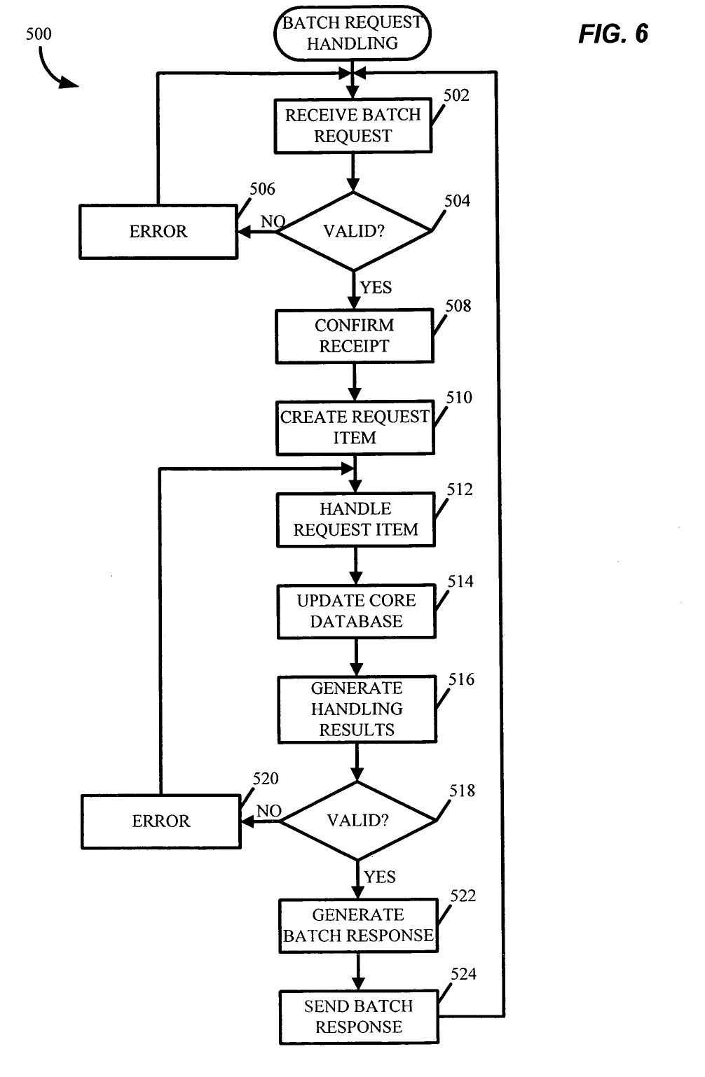

FIG. 6 is an example of a batch request handling routine 500 that may be executed by the subscription system 202 to receive batch requests, handle request items within the batch request and provide a batch response to the provider system 206. As will be understood, many aspects of the routine 500 correspond to the interactions depicted in FIG. 5. Beginning at block 502, the subscription system 202 receives a batch request from the provider system 206. The batch request is validated at block 504. If any aspect of the validation is invalid, the subscription system 202 provides an error message to the provider system 206 at block 506. Otherwise, the subscription system 202 provides an acknowledgement of receipt to the provider system 206 at block 508. At block 510, the subscription system 202 creates the request items from the batch request, and handles each request item at block 512. The core database is updated at block 514 as appropriate. At block 516, the subscription system 202 generates handling results corresponding to the request items. If the handling results are invalid, as determined at block 518, the subscription system 202 generates an error message for the provider system 206 at block 520. As mentioned above, the handling results may be validated according to batch identification, provider identification, number of results, syntax, etc. If validated, a batch response is generated at block 522 and sent to the provider system 206 at block 524.

The following provides examples of the schemas used for the network service interface between subscription system 202 and the provider system 206, which may be a web service interface. As mentioned, the schemas may be implemented using extensible markup language, such as XML, and all schemas may be defined by the subscription system 202 to simplify and provide a common interface for different request items. Although C# style notation is used to described the schemas, the schemas are not limited thereto.

SendBatchRequest—This method is used as the network service interface. The interface is provided by the subscription network service 302 and invoked by the batch request service 312 to send batch requests. In the event the batch request is invalid, a Simple Object Access Protocol (SOAP) exception is generated by the subscription network service 302 containing specific information about the error. A batch response is generated by the subscription system 202 from the batch request. The batch response is sent to the batch reply network service according to the Uniform Resource Locator (URL) specified in the batch request.

Syntax

public void SendBatchRequest ( BatchRequest batchRequest );

Arguments

| | |
|---|---|
| batchRequest | the batch request that the Provider Batch Request |
| | Service sends. It may contain one to many request items. |

QueryBatchResponse—This method is used by the batch request service 312 to query the status of a response for a specific batch request. If the batchID of the partnerCode is invalid, a SOAP exception is generated by the subscription network service 302 containing specific information about the error. A batch response is generated by the subscription system 202 for the specific batchID and PartnerCode. The batch response is sent to the batch reply network service 314 with the URL specified by the callbackUrl. If there is no batch request with the specific batchID in the database, a batch response will be generated with the error that the batch request does not exist, and sent to the batch reply network service with the specified URL.

Syntax

public void QueryBatchResponse (

string PartnerCode,
string batchId,
string callbackurl
);

Arguments

| | |
|---|---|
| PartnerCode | the identifier of the provider. |
| batchId | the identifier of the batch to be queried. |
| callbackUrl | the URL of the callback network service |

SendBatchReponse—This method is used by the subscription service 304 to send batch responses.

Syntax

public void SendBatchResponse ( BatchResponse batchResponse );

Arguments

| | |
|---|---|
| batchResponse | the batch response that the subscription service sends. |
| | The batch response maps to exact one batch request |
| | through the batch ID. |

The following provides examples of schemas used to control the data structure (e.g., naming and layout) of the request items. As mentioned, the schemas may be implemented using extensible markup language, such as XML, and all schemas may be defined by the subscription system 202. The BatchRequest and BatchResponse used in the network service interface may contain multiple Request and Response. Although C# classes are generated from the schema, the schemas are not limited thereto.

EnforcementLevelType—This method defines different enforcement levels that the client system 204 uses to enforce the subscription policy (e.g. download a packet every month). This request item may be invoked based payment for the subscription, resulting in a corresponding enforcement level (e.g., limited function mode, disable mode, etc.)

Syntax

| | |
|---|---|
| <!-- =============================================== | --> |
| <!-- Type definition for the Integration Web Services. | --> |
| <!-- =============================================== | --> |

<xs:element name=“EnforcementLevel” type=“EnforcementLevel” />
<xs:simpleType name=“EnforcementLevel”>

<xs:restriction base=“xs:string”>

<xs:enumeration value=“Level_0” />
<xs:enumeration value=“Level_1” />
<xs:enumeration value=“Level_2” />
<xs:enumeration value=“Level_3” />
<xs:enumeration value=“Level_4” />

</xs:restriction>

</xs:simpleType>

Request is the base class for other request sub-classes. It contains a DeviceName to specify the subscription device 216 to which the request is applied. The DeviceName may be a (Unicode) string, and is 40 characters or less in length.

Syntax

| | |
|---|---|
| <!-- =============================================== | --> |
| <!-- 1. Request | --> |
| <!-- =============================================== | --> |

<xs:element name=“Request” type=“Request”/>
<xs:complexType name=“Request”>

<xs:sequence>

<xs:element name=“DeviceName” type=“xs:string” />

</xs:sequence>

</xs:complexType>

RegisterDeviceRequest asks the subscription network service 302 to register, re-register, and de-register a specific subscription device 216. It basically binds/unbinds the DeviceName and the InitKey or other password associated with the subscription device 216. The main reason to re-register a device is to start a new bootstrap job at the core service side in the case that a legitimate user failed to bootstrap after multiple tries up to the maximum certificate download count. If the InitKey is bound incorrectly to a DeviceName, the re-register can also unbind the InitKey from the DeviceName. However, after a successful client bootstrap, a subscription device is bound to the HWID already and cannot be re-registered anymore. Any device level requests must be issued on the registered subscription devices. A registered subscription device can be de-registered at any time. No device level request can be performed on the de-registered subscription device, which is in the “retired” mode and only used for history.

Syntax

| | |
|---|---|
| <!-- =============================================== | --> |
| <!-- 2. RegisterDeviceRequest | --> |
| <!-- =============================================== | --> |

<xs:element name=“RegisterDeviceRequest”
type=“RegisterDeviceRequest”/>
<xs:complexType name=“RegisterDeviceRequest”>

<xs:complexContent>

<xs:extension base=“Request”>

<xs:sequence>

<xs:element name=“InitKey” type=“xs:string” />
<xs:element name=“Mode”>

<xs:simpleType>

<xs:restriction base=“xs:string”>

<xs:enumeration
value=“Register” />
<xs:enumeration
value=“ReRegister” />
<xs:enumeration
value=“DeRegister” />

</xs:restriction>

</xs:simpleType>

</xs:element>

</xs:sequence>

</xs:extension>

</xs:complexContent>

</xs:complexType>

SubscribeDeviceRequest asks the subscription network service 302 to turn on (begin) or turn off (end) a subscription. Based on this information, the subscription packet is generated periodically for the subscription device 216. If the Mode is “Start”, the BeginDate is the date to start the subscription for the specific subscription device 216. The EndDate is optional and indicates when the subscription will stop. If the Mode is “Stop”, the BeginDate is the date to stop the subscription for the specific subscription device 216 and the EndDate is not used.

Syntax

| | |
|---|---|
| <!-- =============================================== | --> |
| <!-- 3. SubscribeDeviceRequest | --> |
| <!-- =============================================== | --> |

<xs:element name=“SubscribeDeviceRequest”
type=“SubscribeDeviceRequest”/>
<xs:complexType name=“SubscribeDeviceRequest”>

<xs:complexContent>

<xs:extension base=“Request”>

<xs:sequence>

<xs:element name=“BeginDate”
type=“xs:dateTime” />
<xs:element minOccurs=“0”
name=“EndDate” type=“xs:dateTime” />
<xs:element name=“Mode”>

<xs:simpleType>

<xs:restriction base=“xs:string”>

<xs:enumeration value=“Start” />
<xs:enumeration value=“Stop” />

</xs:restriction>

</xs:simpleType>

</xs:element>

</xs:sequence>

</xs:extension>

</xs:complexContent>

</xs:complexType>

PerpetuateDeviceRequest asks the subscription network service 302 to perpetuate the specific subscription device 216. If the subscription device 216 is under subscription at the time, the subscription will be stopped and a perpetual provisioning packet is created for the client. The next time the client downloads the provisioning packet, it will also download the perpetual packet and consume it thus make the subscription device 216 a perpetual device, thereby no longer requiring a subscription.

Syntax

| | |
|---|---|
| <!-- =============================================== | --> |
| <!-- 4. PerpetuateDeviceRequest | --> |
| <!-- =============================================== | --> |
| <xs:element name=“PerpetuateDeviceRequest” | |
| type=“PerpetuateDeviceRequest”/> | |
| <xs:complexType name=“PerpetuateDeviceRequest”> | |

<xs:complexContent>

<xs:extension base=“Request”>
</xs:extension>

</xs:complexContent>

</xs:complexType>

ConfigureDeviceRequest asks the subscription network service 302 to configure the specific subscription device 216. For example, the subscription system 202 may configure the use of the subscription device 216 according to a specified grace period, configure the terms of use (e.g., amount of use, access to features, access to routines), etc. There are two settings at the device level: GracePeriodInMinutes and EnforcementLevel, where EnforcementLevel is described above.

Syntax

| | |
|---|---|
| <!-- ============================================ | --> |
| <!-- 5. ConfigureDeviceRequest | --> |
| <!-- ============================================ | --> |
| <xs:element name=“ConfigureDeviceRequest” | |
| type=“ConfigureDeviceRequest”/> | |
| <xs:complexType name=“ConfigureDeviceRequest”> | |

<xs:complexContent>

<xs:extension base=“Request”>

<xs:sequence>

<xs:element minOccurs=“0”
name=“GracePeriodInMinutes”

type=“xs:int” />

<xs:element minOccurs=“0”
name=“EnforcementLevel”

type=“EnforcementLevel” />

</xs:sequence>

</xs:extension>

</xs:complexContent>

</xs:complexType>

ConfigureDefaultRequest asks the subscription network service 302 to configure the default setting for handling all subscription devices.

Syntax

| | |
|---|---|
| <!-- ============================================ | --> |
| <!-- 6. ConfigureDefaultRequest | --> |
| <!-- ============================================ | --> |
| <xs:element name=“ConfigureDefaultRequest” | --> |
| type=“ConfigureDefaultRequest”/> | |
| <xs:complexType name=“ConfigureDefaultRequest”> | |

<xs:complexContent>

<xs:extension base=“Request”>

<xs:sequence>

<xs:element minOccurs=“0”
name=“MaxCertDownloadCount”

type=“xs:int” />

<xs:element minOccurs=“0”
name=“MaxPacketDownloadCount”

type=“xs:int” />

<xs:element minOccurs=“0”
name=“GracePeriodInMinutes”

type=“xs:int” />

<xs:element minOccurs=“0”
name=“EnforcementLevel”

type=“EnforcementLevel” />

<xs:element minOccurs=“0”
name=“PreProcessPeriodInDays”

type=“xs:int” />

<xs:element minOccurs=“0”
name=“EnforcementPeriod”

type=“xs:int” />

<xs:element minOccurs=“0”
name=“EnforcementPeriodTimeUnit”

type=“EnforcementPeriodTimeUnit” />

</xs:sequence>

</xs:extension>

</xs:complexContent>

</xs:complexType>
<xs:simpleType name=“EnforcementPeriodTimeUnit”>

<xs:restriction base=“xs:string”>

<xs:enumeration value=“Day” />
<xs:enumeration value=“Week” />
<xs:enumeration value=“Month” />

</xs:restriction>

</xs:simpleType>

CreateSubscriptionPacketRequest asks the subscription network service 302 to create a one time subscription packet. The subscription system 202 will generate a subscription packet immediately with the specified EndDate. The client will consume the packet as normal subscription packets.

Syntax

| <!-- ============================================ | | --> |
|---|---|---|
| <!-- 7. | CreateSubscriptionPacketRequest | --> |
| <!-- | Sender: Subscription Svc Receiver: | --> |

Core Svc

| | |
|---|---|
| <!-- ============================================ | --> |
| <xs:element name=“CreateSubscriptionPacketRequest” | |

type=“CreateSubscriptionPacketRequest”>

<xs:complexType name=“CreateSubscriptionPacketRequest”>

<xs:complexContent>

<xs:extension base=“Request”>

<xs:sequence>

<xs:element name=“EndDate”
type=“xs:dateTime” />

</xs:sequence>

</xs:extension>

</xs:complexContent>

</xs:complexType>

BatchRequest is the aggregation of the request items. At least one request item is contained in a batch request, and request items are not sent unless contained in a batch request. A batch request is uniquely identified by batchId, which is a GUID in string format or other universal unique identification. The PartnerCode is created and assigned to the provider by the subscription services management system and embedded in the hardware of the subscription device 216. It conforms to the UPID specification. The callbackUrl is the URL of the batch reply network service 314, which starts with “HTTPS” or uses an otherwise secure channel, and is reachable from the subscription service 304.

Syntax

| <!-- ============================================ | | --> |
|---|---|---|
| <!-- 8. | BatchRequest | --> |
| <!-- | Sender: Partner System Receiver: | --> |

Subscription webservice

| | |
|---|---|
| <!-- ============================================ | --> |
| <xs:element name=“BatchRequest” type=“BatchRequest”/> | |
| <xs:complexType name=“BatchRequest” /> | |

<xs:sequence>

<xs:element minOccurs=“1” name=“BatchId”
type=“xs:int” />
<xs:element name=“PartnerCode” type=“xs:string” />
<xs:element name=“CallbackUrl” type=“xs:string” />
<xs:element name=“RequestList” >

<xs:complexType>

<xs:sequence>

<xs:element maxOccurs=“unbounded”
name=“Item”

type=“Request” />

</xs:sequence>

</xs:complexType>

</xs:element>

</xs:sequence>

</xs:complexType>

Response is the result of a specific request. Reponses are aggregated into the batch response and sent to the batch reply network service 314. The “Pending” status means the request items have been handled successfully but it is a lengthy job and not completed yet. An example is the SubscribeDeviceRequest job with Mode is “Start”. The core service 306 will create a scheduler job for the request, but the job won't be completed until a stop subscription request is received or it reaches the EndDate in the original SubscribeDeviceRequest. As long as the scheduler job is created, subscription system 202 considers the request item is handled successfully and sets the response status to pending.

Syntax

| | |
|---|---|
| <!-- =============================================== | --> |
| <!-- 1. Response | --> |
| <!-- =============================================== | --> |
| <xs:element name=“Response” type=“Response”/> | |
| <xs:complexType name=“Response”> | |

<xs:sequence>

<xs:element name=“DeviceName” type=“xs:string” />
<xs:element name=“Message” type=“xs:string” />
<xs:element name=“Status”>

<xs:simpleType>

<xs:restriction base=“xs:string”>

<xs:enumeration value=“Success” />
<xs:enumeration value=“Warning” />
<xs:enumeration value=“Pending” />
<xs:enumeration value=“Error” />
<xs:enumeration
value=“ErrorDuplicatedDeviceName” />
<xs:enumeration
value=“ErrorInvalidInitKey” />
<xs:enumeration
value=“ErrorDuplicatedInitKey” />
<xs:enumeration
value=“ErrorDeviceNotFound” />
<xs:enumeration
value=“ErrorInvalidReregisterRequest” />
<xs:enumeration
value=“ErrorInvalidDeviceType” />
<xs:enumeration
value=“ErrorDeviceRetired” />
<xs:enumeration
value=“ErrorDeviceSubscribed” />
<xs:enumeration
value=“ErrorDeviceUnsubscribed” />

</xs:restriction>

</xs:simpleType>

</xs:element>

</xs:sequence>

</xs:complexType>

BatchResponse is the aggregation of the response items. It contains a status to indicate whether all request items in the batch request are handled successfully. The PartnerCode, and callbackUrl can be used as a verification check. The BatchId is used to match the corresponding BatchRequest.

Syntax

| <!-- ============================================ | | --> |
|---|---|---|
| <!-- 2. | BatchResponse | --> |
| <!-- | Sender: Subscription Service Receiver: | --> |

Partner Notification

| | | |
|---|---|---|
| <!-- | Webservice | --> |

| | |
|---|---|
| <!-- ============================================ | --> |
| <xs:element name=“BatchResponse” type=“BatchResponse”/> | |
| <xs:complexType name=“BatchResponse”> | |

<xs:sequence>

<xs:element minOccurs=“1” name=“BatchId”
type=“xs:int” />
<xs:element name=“PartnerCode” type=“xs:string” />
<xs:element name=“CallbackUrl” type=“xs:string” />
<xs:element name=“Message” type=“xs:string” />
<xs:element name=“Status”>

<xs:simpleType>

<xs:restriction base=“xs:string”>

<xs:enumeration value=“Success” />
<xs:enumeration value=“Error” />
<xs:enumeration value=“Pending” />
<xs:enumeration
value=“ErrorDuplicatedBatchId” />
<xs:enumeration
value=“ErrorInvalidPartnerId” />
<xs:enumeration
value=“ErrorInvalidCallbackUrl” />
<xs:enumeration
value=“ErrorInvalidBatchId” />
<xs:enumeration
value=“ErrorRequestListEmpty” />

</xs:restriction>

</xs:simpleType>

</xs:element>
<xs:element name=“ResponseList”>

<xs:complexType>

<xs:sequence>

<xs:element maxOccurs=“unbounded”
name=“Item”

type=“Response”/>

</xs:sequence>
</xs:complexType>

</xs:element>

</xs:sequence>

</xs:complexType>

Although the forgoing text sets forth a detailed description of numerous different embodiments of the invention, it should be understood that the scope of the invention is defined by the words of the claims set forth at the end of this patent. The detailed description is to be construed as exemplary only and does not describe every possibly embodiment of the invention because describing every possible embodiment would be impractical, if not impossible. Numerous alternative embodiments could be implemented, using either current technology or technology developed after the filing date of this patent, which would still fall within the scope of the claims defining the invention.

Thus, many modifications and variations may be made in the techniques and structures described and illustrated herein without departing from the spirit and scope of the present invention. Accordingly, it should be understood that the methods and apparatus described herein are illustrative only and are not limiting upon the scope of the invention.

1. A computer-readable medium having computer-executable instructions for implementing a method of supporting communication in a network for a subscription to a subscription device, the computer executable instructions comprising instructions for:
exchanging a plurality of requests grouped into a first batch according to first extensible markup language schema between a subscription provider and a subscription services manager in the network; and
exchanging a plurality of responses grouped into a second batch according to a second extensible markup language schema between the subscription provider and the subscription services manager in the network, wherein each response corresponds to a request from among the plurality of requests.

2. The computer-readable medium having computer-executable instructions of claim 1, wherein the first and second extensible markup language schemas are specified by the subscription services manager.

3. The computer-readable medium having computer-executable instructions of claim 1, wherein the plurality of requests grouped into the first batch are organized according to a priority of execution.

4. The computer-readable medium having computer-executable instructions of claim 3, wherein the priority of execution comprises a logical order of execution.

5. The computer-readable medium having computer-executable instructions of claim 1, wherein the plurality of requests grouped into a first batch are organized according to a subscription device to which the request pertains.

6. The computer-readable medium having computer-executable instructions of claim 1, wherein at least one of the plurality of requests relates to management of a subscription for use of a subscription device.

7. The computer-readable medium having computer-executable instructions of claim 1, wherein at least one of the plurality of requests comprises a request for one of the group consisting of: registering a subscription device, re-registering a subscription device, de-registering a subscription device, initiating a subscription for a subscription device, terminating a subscription for a subscription device, enforcing terms of a subscription for a subscription device, configure a subscription device, configure a default setting for handling a subscription device, perpetuating a subscription for a subscription device, and creating a subscription packet with the specified and date for a subscription device.

8. The computer-readable medium having computer-executable instructions of claim 1, wherein each response within the plurality of responses grouped into a second batch comprises a result corresponding to at least one of the one or more requests.

9. The computer-readable medium having computer-executable instructions of claim 1, wherein at least one of the plurality of responses relates to a management of the subscription for use of a subscription device.

10. The computer-readable medium having computer-executable instructions of claim 1, wherein at least one of the plurality of responses comprises a result corresponding to one of the group consisting of: registering a subscription device, re-registering a subscription device, de-registering a subscription device, periodically generating a subscription packet for a subscription of a subscription device which specifies a time period of the subscription, establishing an enforcement level for an enforcement module of the subscription device to utilize to enforce a subscription policy, configuring a subscription device, configuring a subscription device to a default setting, generating a perpetual provisioning packet to cause a subscription device to become a perpetual device, and creating a one-time subscription packet to cause a subscription device to enter a one-time subscription.

11. The computer-readable medium having computer-executable instructions of claim 1, further comprising:
receiving the first batch from the subscription provider, wherein the first batch comprises a batch identification identifying the first batch, a subscription provider identification identifying the subscription provider and an input parameter relating to the number of requests grouped into the first batch;
validating the first batch according to the batch identification, the subscription provider identification, and the input parameter;
receiving the plurality of responses from a core service of the subscription services manager, wherein the core service extracts and handles each request from the first batch to generates a response to each request;
validating each of the plurality of responses according the batch identification, the subscription provider identification, and to determine that the number of responses correspond with the number of requests and that each response contains information; and
generating the second batch according to the second extensible markup language schema.

12. A method of communicating between a requesting process and a serving process supporting communication in a network for a device subscription comprising:
processing a first call for exchanging a plurality of requests grouped into a batch request between a subscription provider and a subscription services manager in the network, wherein the batch request is generated according to a first schema specified by the subscription services manager; and
processing a second call for exchanging a plurality of responses grouped into a batch response between the subscription provider and the subscription services manager in the network, wherein the batch response is generated according to a second schema specified by the subscription services manager, and wherein each of responses corresponds to one of the plurality of requests and the second call corresponds to the first call.

13. The method of claim 12, wherein the first schema specified by the subscription services manager is a first extensible markup language schema and wherein the second schema specified by the subscription services manager is a second extensible markup language schema.

14. The method of claim 12, wherein processing a first call for exchanging a plurality of requests grouped into batch request comprises:
issuing, by the requesting process, a SendBatchRequest call to send the batch request;
receiving, by the serving process, the SendBatchRequest call and sending the plurality of requests grouped into the batch request to a core service for generating the plurality of responses; and
issuing, by the serving process to the requesting process, the plurality of responses grouped into the batch response.

15. The method of claim 12, wherein processing a second call for exchanging a plurality of responses grouped into a batch response comprises:
issuing, by the serving process to the requesting process, a SendBatchResponse call to send the batch response including the plurality of responses; and
receiving, by the requesting process, the SendBatchResponse call.

16. The method of claim 12, further comprising issuing, by the requesting process, a BatchRequest call to aggregate the plurality of requests into the batch request.

17. The method of claim 12, further comprising issuing, by the serving process, a BatchResponse call to aggregate the plurality of responses into the batch response.

18. The method of claim 12, further comprising:
issuing, by the requesting process, a QueryBatchResponse call to query the status of a batch response for the batch request;
receiving, by the serving process, the QueryBatchResponse call;
issuing, by the serving process to the requesting process, a response related to the status of the batch response for the batch request specified by the QueryBatchResponse call.

19. A computer adapted for participation in a subscription network, the computer comprising:
a network communication device for exchanging data via a network;
a memory storing machine-readable instructions; and
a processor for executing the machine-readable instructions performing a method comprising:
processing a first call for receiving a plurality of requests from a batch request service, the plurality of requests groups into a batch request according to batch request schema;
generating a plurality of responses corresponding to the plurality of requests;
processing a second call for aggregating the plurality of responses into a batch response according to a batch reply schema and sending the plurality of responses to a batch reply service.

20. The computer of claim 19, wherein the memory stores instructions for performing the method further comprising one or more of the group consisting of:
processing a RegisterDeviceRequest call to register, re-register or de-register a subscription device;
processing a SubscribeDeviceRequest call to initiate or terminate a subscription for a subscription device;
processing an EnforcementLevelType call to enforce a subscription policy for a subscription device;
processing a ConfigureDeviceRequest call to configure a subscription device;
processing a ConfigureDefaultRequest call to configure a default setting for handling a subscription device;
processing a PerpetuateDeviceRequest call to perpetuate a subscription of a subscription device; and
processing a CreateSubscriptionPacketRequest call to create a subscription packet for a subscription device with a specific end date.
